(19) United States
(12) Patent Application Publication
(10) Pub. No.: US 2025/0237899 A1
(43) Pub. Date: Jul. 24, 2025

(54) LIGHTING DEVICE

(71) Applicant: Japan Display Inc., Tokyo (JP)

(72) Inventor: Takayuki IMAI, Tokyo (JP)

(21) Appl. No.: 19/174,644

(22) Filed: Apr. 9, 2025

Related U.S. Application Data
(63) Continuation of application No. PCT/JP2023/028793, filed on Aug. 7, 2023.

(30) Foreign Application Priority Data
Oct. 25, 2022 (JP) 2022-170950

(51) Int. Cl. G02F 1/133; G02F 1/1343; G02F 1/1362

(52) U.S. Cl. CPC G02F 1/13306; G02F 1/13439; G02F 1/136286

(57) ABSTRACT

A lighting device includes a control device controlling an optical element. The control device includes a signal generating circuit section, a switch circuit section including first to fourth output channels electrically connected to first to fourth transparent electrodes of a liquid crystal cell of the optical element, and a first voltage signal line and a second voltage signal line each transmitting voltage signals generated by the signal generating circuit section. In a first subframe of one frame period, the switch circuit section drives so that the first voltage signal line is conductive with the first output channel and the second voltage signal line is conductive with the second output channel. In a second subframe of one frame period, the switch circuit section drives so that the first voltage signal line is conductive with the third output channel and the second voltage signal line is conductive with the fourth output channel.

### CROSS-REFERENCE TO RELATED APPLICATIONS

This application is a Continuation of International Patent Application No. PCT/JP2023/028793, filed on Aug. 7, 2023, which claims the benefit of priority to Japanese Patent Application No. 2022-170950, filed on Oct. 25, 2022, the entire contents of which are incorporated herein by reference.

### FIELD

An embodiment of the present invention relates to a lighting device using a liquid crystal to control a distribution of light emitted from a light source.

### BACKGROUND

An optical element which is a so-called liquid crystal lens has been conventionally known in which a change in the refractive index of a liquid crystal is utilized by adjusting a voltage applied to the liquid crystal. Further, a lighting device including a light source and a liquid crystal lens has been developed (for example, see Japanese laid-open patent publication No. 2021-117344).

### SUMMARY

A lighting device according to an embodiment of the present invention includes a light source, an optical element including a first liquid crystal cell and a second liquid crystal cell and configured to diffuse and transmit light emitted from the light source, and a control device connected to the optical element and configured to control the optical element. Each of the first liquid crystal cell and the second liquid crystal cell includes a first substrate on which a first transparent electrode and a second transparent electrode extend in a first direction and are alternately arranged in a second direction orthogonal to the first direction, a second substrate on which a third transparent electrode and a fourth transparent electrode extend in the second direction and are alternately arranged in the first direction, and a liquid crystal layer between the first substrate and the second substrate. The control device includes a switch circuit section including a first output channel electrically connected to the first transparent electrode of the first liquid crystal cell, a second output channel electrically connected to the second transparent electrode of the first liquid crystal cell, a third output channel electrically connected to the third transparent electrode of the first liquid crystal cell, and a fourth output channel electrically connected to the fourth transparent electrode of the first liquid crystal cell, a signal generating circuit section configured to generate a plurality of voltage signals to be input to the first transparent electrode, the second transparent electrode, the third transparent electrode, and the fourth transparent electrode of each of the first liquid crystal cell and the second liquid crystal cell, and a first voltage signal line and a second voltage signal line connected to the switch circuit section and the signal generating circuit section, the first voltage signal line and the second voltage signal line each transmitting one of the plurality of voltage signals. One frame period includes a first subframe period and a second subframe period. In the first subframe period, the switch circuit section drives so that the first voltage signal line and the first output channel are electrically connected to each other and the second voltage signal line and the second output channel are electrically connected to each other. In the second subframe period, the switch circuit section drives so that the first voltage signal line and the third output channel are electrically connected to each other and the second voltage signal line and the fourth output channel are electrically connected to each other.

A lighting device according to an embodiment of the present invention includes a light source, an optical element comprising a first liquid crystal cell and a second liquid crystal cell and configured to diffuse and transmit light emitted from the light source, and a control device connected to the optical element and configured to control the optical element. Each of the first liquid crystal cell and the second liquid crystal cell includes a first substrate on which a first transparent electrode and a second transparent electrode extend in a first direction and are alternately arranged in a second direction orthogonal to the first direction, a second substrate on which a third transparent electrode and a fourth transparent electrode extend in the second direction and are alternately arranged in the first direction, and a liquid crystal layer between the first substrate and the second substrate. The control device includes a switch circuit section including a first output channel electrically connected to the first transparent electrode of the first liquid crystal cell, a second output channel electrically connected to the second transparent electrode of the first liquid crystal cell, a third output channel electrically connected to the third transparent electrode of the first liquid crystal cell, a fourth output channel electrically connected to the fourth transparent electrode of the first liquid crystal cell, a fifth output channel electrically connected to the first transparent electrode of the second liquid crystal cell, a sixth output channel electrically connected to the second transparent electrode of the second liquid crystal cell, a seventh output channel electrically connected to the third transparent electrode of the second liquid crystal cell, an eighth output channel electrically connected to the fourth transparent electrode of the second liquid crystal cell, a signal generating circuit section configured to generate a plurality of voltage signals to be input to the first transparent electrode, the second transparent electrode, the third transparent electrode, and the fourth transparent electrode of each of the first liquid crystal cell and the second liquid crystal cell, and a first voltage signal line, a second voltage signal line, a third voltage signal line, and a fourth voltage signal line connected to the switch circuit section and the signal generating circuit section, the first voltage signal line, the second voltage signal line, the third voltage signal line, and the fourth voltage signal line each transmitting one of the plurality of voltage signals. One frame period includes a first subframe period and a second subframe period. In the first subframe period, the switch circuit section drives so that the first voltage signal line, the second voltage signal line, the third voltage signal line, and the fourth voltage signal line are electrically connected to the first output channel, the second output channel, the third output channel, and the fourth output channel, respectively. In the second subframe period, the switch circuit section drives so that the first voltage signal line, the second voltage signal line, the third voltage signal line, and the fourth voltage signal line are electrically connected to the fifth output channel, the sixth output channel, the seventh output channel, and the eighth output channel, respectively.

### BRIEF DESCRIPTION OF DRAWINGS

FIG. 1 is a schematic diagram showing a configuration of a lighting device according to an embodiment of the present invention.

FIG. 2 is a block diagram showing a configuration of a lighting device according to an embodiment of the present invention.

FIG. 3A is a schematic cross-sectional view showing a configuration of a lighting device according to an embodiment of the present invention.

FIG. 3B is a schematic cross-sectional view showing a configuration of a lighting device according to an embodiment of the present invention.

FIG. 4A is a schematic plan view showing an electrode pattern of a liquid crystal cell included in an optical element of a lighting device according to an embodiment of the present invention.

FIG. 4B is a schematic plan view showing an electrode pattern of a liquid crystal cell included in an optical element of a lighting device according to an embodiment of the present invention.

FIG. 5A is a schematic diagram illustrating optical characteristics of a liquid crystal cell included in an optical element of a lighting device according to an embodiment of the present invention.

FIG. 5B is a schematic diagram illustrating optical characteristics of a liquid crystal cell included in an optical element of a lighting device according to an embodiment of the present invention.

FIG. 6A is a timing chart showing voltage signals input to transparent electrodes of liquid crystal cells to control a light distribution in a lighting device according to an embodiment of the present invention.

FIG. 6B is a timing chart showing voltage signals input to transparent electrodes of liquid crystal cells to control a light distribution in a lighting device according to an embodiment of the present invention.

FIG. 6C is a timing chart showing voltage signals input to transparent electrodes of liquid crystal cells to control a light distribution in a lighting device according to an embodiment of the present invention.

FIG. 7 is a block diagram showing a configuration of a lighting device according to an embodiment of the present invention.

FIG. 8 is a timing chart showing voltage signals input to transparent electrodes of liquid crystal cells to control a light distribution in a lighting device according to an embodiment of the present invention.

FIG. 9 is a block diagram showing a configuration of a lighting device according to an embodiment of the present invention.

### DESCRIPTION OF EMBODIMENTS

An optical element of a lighting device includes a control circuit for controlling a light distribution, and the control circuit includes a digital-to-analog converter circuit (DAC) and an amplifier circuit (AMP) that occupy a large area. In a conventional optical element, a voltage signal is generated for each transparent electrode that applies a voltage to the liquid crystal, and the number of DACs and AMPs increases when the optical element has the large number of transparent electrodes. However, when the number of DACs and AMPs that occupy a large area increases, the control circuit becomes larger and the manufacturing cost increases. Therefore, it has been desired to reduce the number of DACs and AMPs included in the control circuit and reduce the manufacturing cost.

In view of the above problem, an embodiment of the present invention can provide a lighting device with reduced manufacturing costs.

In the following description, each of the embodiments of the present invention is described with reference to the drawings. However, the present invention can be implemented in various modes without departing from the gist of the invention and should not be interpreted as being limited to the description of the embodiments exemplified below.

Although the drawings may be schematically represented in terms of width, thickness, shape, and the like of each part as compared with their actual mode in order to make explanation clearer, they are only an example and an interpretation of the present invention is not limited. In addition, in the drawings, the same reference numerals are provided to the same elements as those described previously with reference to preceding figures and repeated explanations may be omitted accordingly.

In the case when a single film is processed to form a plurality of structural bodies, each structural body may have different functions and roles, and the bases formed beneath each structural body may also be different. However, the plurality of structural bodies is derived from films formed in the same layer by the same process and have the same material. Therefore, the plurality of these films is defined as existing in the same layer.

When expressing a mode in which another structure is arranged over a certain structure, in the case where it is simply described as “over”, unless otherwise noted, a case where another structure is arranged directly over a certain structure as if in contact with that structure, and a case where another structure is arranged via yet another structure over a certain structure, are both included.

### First Embodiment

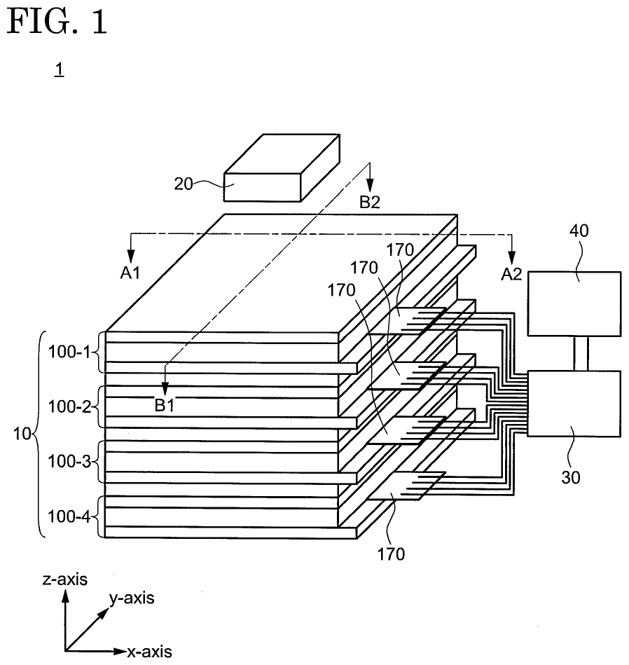

A lighting device 1 according to an embodiment of the present invention is described with reference to FIGS. 1 to 6C.

### [1. Configuration of Lighting Device 1]

FIG. 1 is a schematic diagram showing a configuration of the lighting device 1 according to an embodiment of the present invention. As shown in FIG. 1, the lighting device 1 includes an optical element 10, a light source 20, a control device 30, and a power source 40.

The optical element 10 includes four liquid crystal cells 100 (a first liquid crystal cell 100-1, a second liquid crystal cell 100-2, a third liquid crystal cell 100-3, and a fourth liquid crystal cell 100-4). In the optical element 10, the first liquid crystal cell 100-1, the second liquid crystal cell 100-2, the third liquid crystal cell 100-3, and the fourth liquid crystal cell 100-4 are stacked in the z-axis direction in this order from the side closer to the light source 20. In addition, although the configuration in which the optical element 10 includes four liquid crystal cells 100 is described below, the number of liquid crystal cells 100 included in the optical element 10 is not limited to four. It is sufficient that the optical element 10 includes at least two liquid crystal cells 100. The details of the configuration of the optical element 10 are described later.

The light source 20 can emit light to the optical element 10. The light emitted from the light source 20 is incident on the first liquid crystal cell 100-1 and is irradiated from the fourth liquid crystal cell 100-4. In the lighting device 1, the diffusion and polarization of light are controlled by the four liquid crystal cells 100 included in the optical element 10, and the light distribution of the light irradiated from the fourth liquid crystal cell 100-4 can be changed. That is, the optical element 10 can transmit the light emitted from the light source 20 in a diffusible manner and control the light distribution. For example, light emitting diodes (LEDs) can be used for the light source 20. However, the light source 20 is not limited thereto. The light source 20 may be any element or device that can emit light.

The control device 30 is connected to the optical element 10 and can control the optical element 10. The control device 30 includes, for example, a central processing unit (CPU), a micro processing unit (MPU), an integrated circuit (IC), an application specific integrated circuit (ASIC), a field-programmable gate array (FPGA), or a random access memory (RAM). Although a detailed description is omitted, the control device 30 is connected to the light source 20 and can also control the light source 20. The configuration of the control device 30 is described in detail later.

The power supply 40 is connected to the control device 30 and can supply power to the control device 30. That is, the power supply 40 can generate a predetermined voltage. For example, the power supply 40 can generate two voltages (e.g., 3.3 V and 30 V). However, voltages generated by the power supply 40 are not limited thereto. The voltages generated by the power supply 40 may include GND (e.g., 0 V). In addition, for convenience, even in the case of GND, it may be described that a voltage is generated in the present specification.

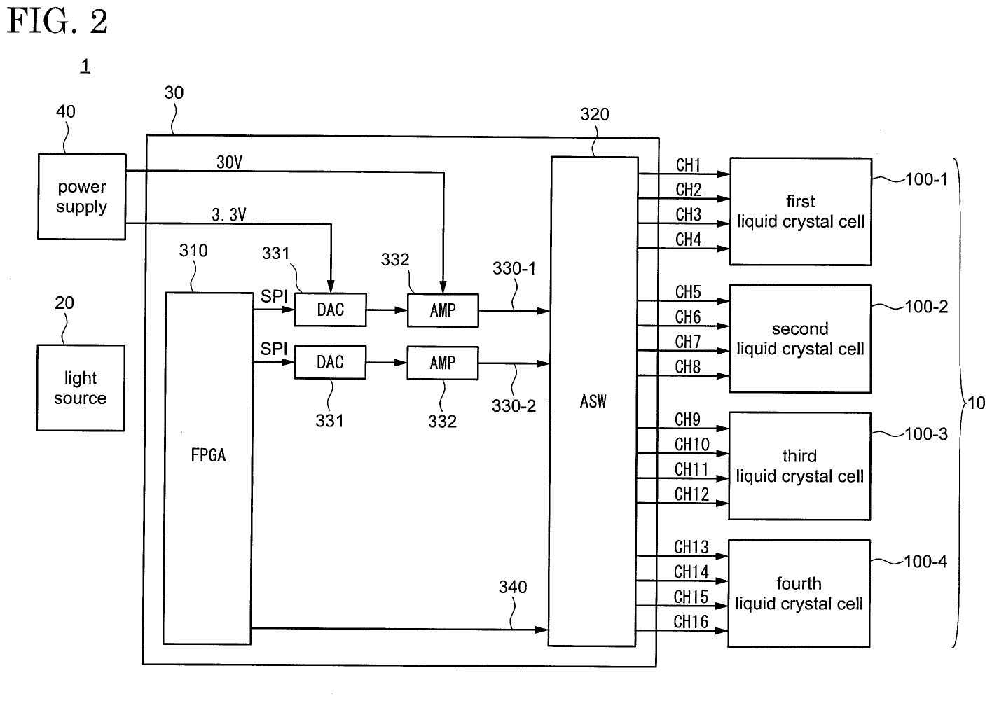

FIG. 2 is a block diagram showing a configuration of the lighting device 1 according to an embodiment of the present invention. As shown in FIG. 2, the control device 30 includes a signal generating circuit section 310, a switch circuit section 320, a first voltage signal line 330-1, a second voltage signal line 330-2, and a timing control signal line 340.

The signal generating circuit section 310 can perform arithmetic processing using data or information. Specifically, the signal generating circuit section 310 can generate a plurality of voltage signals to be input to the liquid crystal cell 100 based on a predetermined program. The signal generating circuit section 310 can also generate a timing control signal to control the switch circuit section 320 according to the voltage signal output from the signal generating circuit section 310. Although the signal generating circuit section 310 is, for example, an FPGA, the signal generating circuit is not limited thereto.

The signal generating circuit section 310 and the switch circuit section 320 are connected via the first voltage signal line 330-1 and the second voltage signal line 330-2. Therefore, two voltage signals of the plurality of voltage signals generated by the signal generating circuit section 310 are input to the switch circuit section 320 via the first voltage signal line 330-1 and the second voltage signal line 330-2. A digital-to-analog conversion circuit (DAC) 331 and an amplifier circuit (AMP) 332 are connected to each of the first voltage signal line 330-1 and the second voltage signal line 330-2. The DAC 331 and the AMP 332 are supplied with voltages of 3.3 V and 30 V, respectively, from the power supply 40. The voltage signal output from the signal generating circuit section 310 is converted into a digital signal by the DAC 331, the voltage is amplified by the AMP 332, and the signal is input to the switch circuit section 320. In addition, hereinafter, it is described that the voltage signal output from the signal generating circuit unit 310 includes the voltage signal that is converted into the digital signal by the DAC 331 and is amplified by the AMP 332.

The switch circuit section 320 includes 16 output channels CH (first output channel CH1 l to sixteenth output channel CH16). The timing control signal is input to the switch circuit section 320 via a timing control signal line 340. The timing control signal includes information about two output channels CH that are conductive with (electrically connected to) the first voltage signal line 330-1 and the second voltage signal line 330-2. That is, the timing control signal includes information about an output channel CH that is selected according to two voltage signals input from the signal generating circuit section 310 to the first voltage signal line 330-1 and the second voltage signal line 330-2. The switch circuit section 320 can drive based on the timing control signal so that the first voltage signal line 330-1 and the second voltage signal line 330-2 are conductive with two of the first output channel CH1 to the sixteenth output channel CH16. For example, the switch circuit section 320 drives so that the first voltage signal line 330-1 and the second voltage signal line 330-2 are conductive with the first output channel CH1 and the second output channel CH2, respectively. In this case, two voltage signals generated by the signal generating circuit section 310 are input to the switch circuit section 320 via the first voltage signal line 330-1 and the second voltage signal line 330-2, and are output from the first output channel CH1 and the second output channel CH2. In addition, in this case, the first voltage signal line 330-1 and the second voltage signal line 330-2 are not conductive with the third output channel CH3 to the sixteenth output channel CH16. That is, non-conductive states are set between the first voltage signal line 330-1 and the second voltage signal line 330-2 and the third output channel CH3 to the sixteenth output channel CH16. That is, each of the third output channel CH3 to the sixteenth output channel CH16 is in a high impedance state. Although the switch circuit section 320 is, for example, an analog switch circuit (ASW), the switch circuit section 320 is not limited thereto.

The first output channel CH1 to the fourth output channel CH4 are connected to the first liquid crystal cell 100-1 via flexible printed circuits (FPCs) 170 (see FIG. 1). The fifth output channel CH5 to the eighth output channel CH8 are connected to the second liquid crystal cell 100-2 via FPCs 170. The ninth output channel CH9 to the twelfth output channel CH12 are connected to the third liquid crystal cell 100-3 via FPCs 170. The thirteenth output channel CH13 to the sixteenth output channel CH16 are connected to the fourth liquid crystal cell 100-4 via FPCs 170.

### [2. Configuration of Optical Element 10]

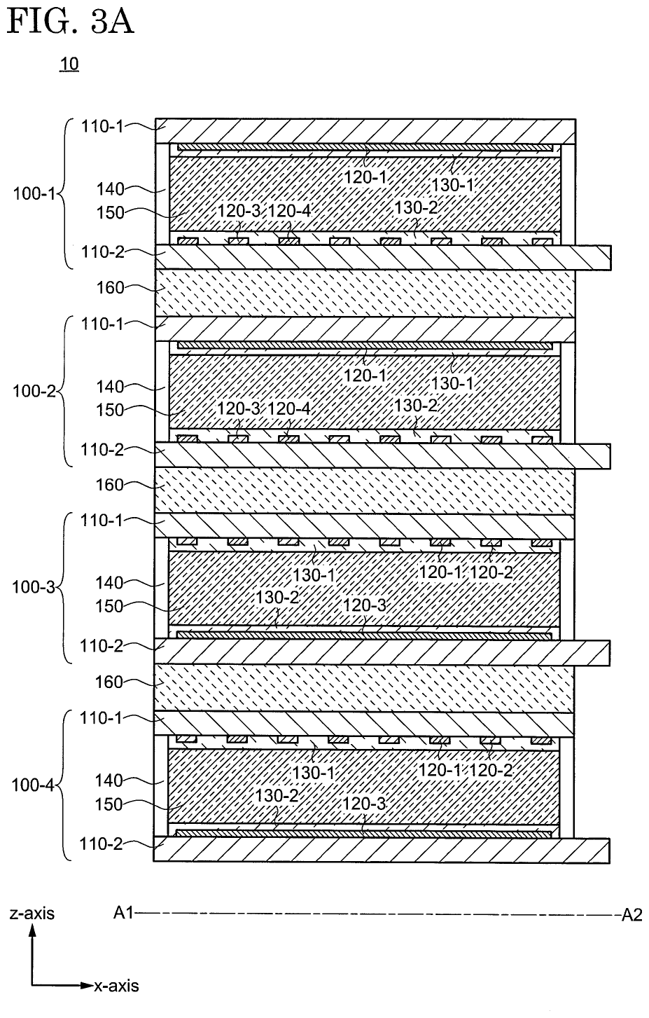

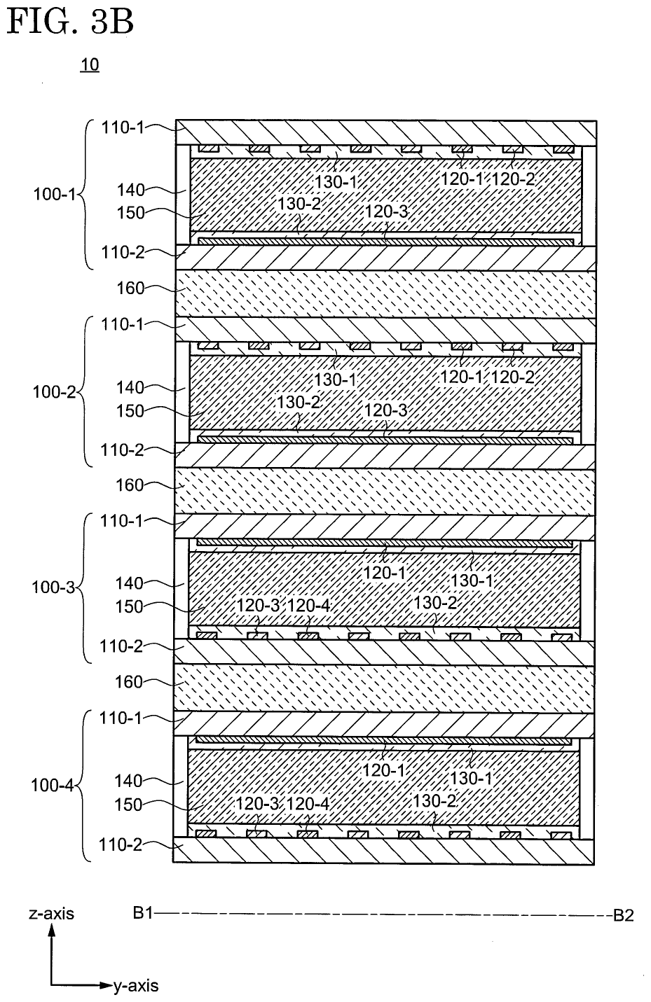

FIGS. 3A and 3B are schematic cross-sectional views showing a configuration of a lighting device 1 according to an embodiment of the present invention. Specifically, FIG. 3A is a cross-sectional view of the optical element 10 taken along a line A1-A2 in FIG. 1, and FIG. 3B is a cross-sectional view of the optical element 10 taken along a line B1-B2 in FIG. 1.

As shown in FIGS. 3A and 3B, each of the first liquid crystal cell 100-1 to the fourth liquid crystal cell 100-4 includes a first substrate 110-1, a second substrate 110-2, a plurality of first transparent electrodes 120-1, a plurality of second transparent electrodes 120-2, a plurality of third transparent electrodes 120-3, a plurality of fourth transparent electrodes 120-4, a first alignment film 130-1, a second alignment film 130-2, a sealant 140, and a liquid crystal layer 150. The first transparent electrodes 120-1 and the second transparent electrodes 120-2 are alternately provided on the first substrate 110-1. Further, the first alignment film 130-1 is provided on the first substrate 110-1 so as to cover the first transparent electrodes 120-1 and the second transparent electrodes 120-2. The third transparent electrodes 120-3 and the fourth transparent electrode 120-4 are alternately provided on the second substrate 110-2. Further, the second alignment film 130-2 is provided on the second substrate 110-2 so as to cover the third transparent electrodes 120-3 and the fourth transparent electrodes 120-4. The first substrate 110-1 and the second substrate 110-2 are disposed so that the first transparent electrodes 120-1 and the second transparent electrodes 120-2 face the third transparent electrodes 120-3 and the fourth transparent electrodes 120-4, and are bonded via a sealing member 140 provided on the periphery of the first substrate 110-1 and the second substrate 110-2. A liquid crystal is sealed in a space surrounded by the first substrate 110-1 (more specifically, the first alignment film 130-1), the second substrate 110-2 (more specifically, the second alignment film 130-2), and the sealing member 140, and the liquid crystal layer 150 is provided between the first substrate 110-1 and the second substrate 110-2.

An optical elastic resin layer 160 is provided between the first liquid crystal cell 100-1 and the second liquid crystal cell 100-2. Similarly, optical elastic resin layers 160 are provided between the second liquid crystal cell 100-2 and the third liquid crystal cell 100-3, and between the third liquid crystal cell 100-3 and the fourth liquid crystal cell 100-4. For example, an adhesive containing a light-transmitting acrylic resin can be used for the optical elastic resin layer 160. That is, the optical elastic resin layer 160 can bond and fix two adjacent liquid crystal cells 100 together.

For example, a rigid substrate having light-transmitting properties such as a glass substrate, a quartz substrate, or a sapphire substrate is used as each of the first substrate 110-1 and the second substrate 110-2. Further, a flexible substrate having light-transmitting properties such as a polyimide resin substrate, an acrylic resin substrate, a siloxane resin substrate, or a fluorine resin substrate can also be used as each of the first substrate 110-1 and the second substrate 110-2.

Each of the first transparent electrode 120-1, the second transparent electrode 120-2, the third transparent electrode 120-3, and the fourth transparent electrode 120-4 functions as an electrode for forming an electric field in the liquid crystal layer 150. For example, a transparent conductive material such as indium tin oxide (ITO) or indium zinc oxide (IZO) is used for each of the first transparent electrode 120-1, the second transparent electrode 120-2, the third transparent electrode 120-3, and the fourth transparent electrode 120-4. Further, a non-transparent metal material is used for each of the first transparent electrode 120-1, the second transparent electrode 120-2, the third transparent electrode 120-3, and the fourth transparent electrode 120-4.

In the first liquid crystal cell 100-1 and the second liquid crystal cell 100-2, the first transparent electrode 120-1 and the second transparent electrode 120-2 extend in the x-axis direction, and the third transparent electrode 120-3 and the fourth transparent electrode 120-4 extend in the y-axis direction. In the third liquid crystal cell 100-3 and the fourth liquid crystal cell 100-4, the first transparent electrode 120-1 and the second transparent electrode 120-2 extend in the y-axis direction, and the third transparent electrode 120-3 and the fourth transparent electrode 120-4 extend in the x-axis direction.

In addition, when the first transparent electrode 120-1 to the fourth transparent electrode 120-4 are not particularly distinguished from each other, they may be referred as a transparent electrode 120 in the following description.

Each of the first alignment film 130-1 and the second alignment film 130-2 aligns the liquid crystal molecules in the liquid crystal layer 150 in a predetermined direction. For example, a polyimide resin or the like can be used for each of the first alignment film 130-1 and the second alignment film 130-2. In addition, each of the first alignment film 130-1 and the second alignment film 130-2 may be imparted with alignment properties by an alignment treatment such as a rubbing method or a photo-alignment method. The rubbing method is a method of rubbing the surface of the alignment film in one direction. The photo-alignment method is a method of irradiating an alignment film with linearly polarized ultraviolet rays.

An alignment treatment is performed on the first alignment film 130-1 so that the liquid crystal molecules on the first substrate 110-1 side of the liquid crystal layer 150 are aligned in a direction perpendicular to the extending direction of the first transparent electrode 120-1 and the second transparent electrode 120-2. An alignment treatment is performed on the second alignment film 130-2 so that the liquid crystal molecules on the second substrate 110-2 side of the liquid crystal layer 150 are aligned in a direction perpendicular to the extending direction of the third transparent electrode 120-3 and the fourth transparent electrode 120-4. Therefore, in the first liquid crystal cell 100-1 and the second liquid crystal cell 100-2, the long axes of the liquid crystal molecules on the side of the first substrate 110-1 are aligned in the y-axis direction, and the long axes of the liquid crystal molecules on the side of the second substrate 110-2 are aligned in the x-axis direction. Further, in the third liquid crystal cell 100-3 and the fourth liquid crystal cell 100-4, the long axes of the liquid crystal molecules on the side of the first substrate 110-1 are aligned in the x-axis direction, and the long axes of the liquid crystal molecules on the side of the second substrate 110-2 are aligned in the y-axis direction.

An adhesive material containing epoxy resin or acrylic resin is used for the sealing member 140. The adhesive material may be an ultraviolet curing type or a heat curing type.

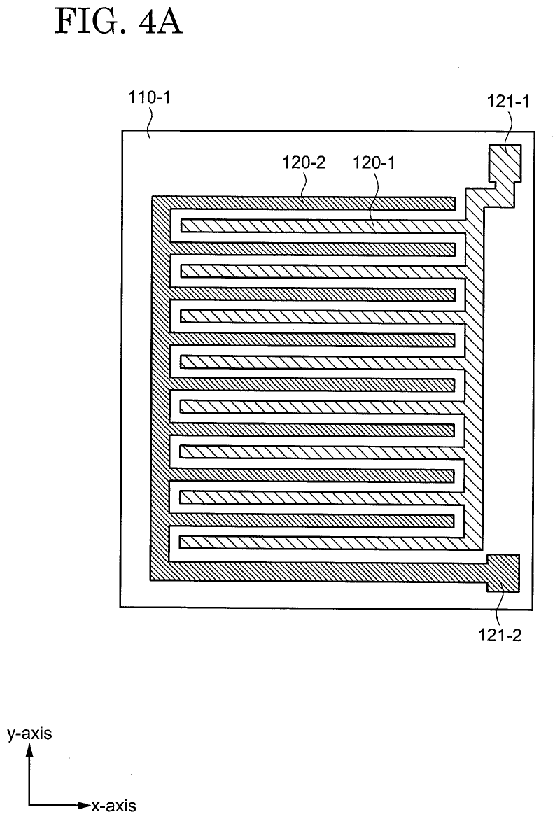

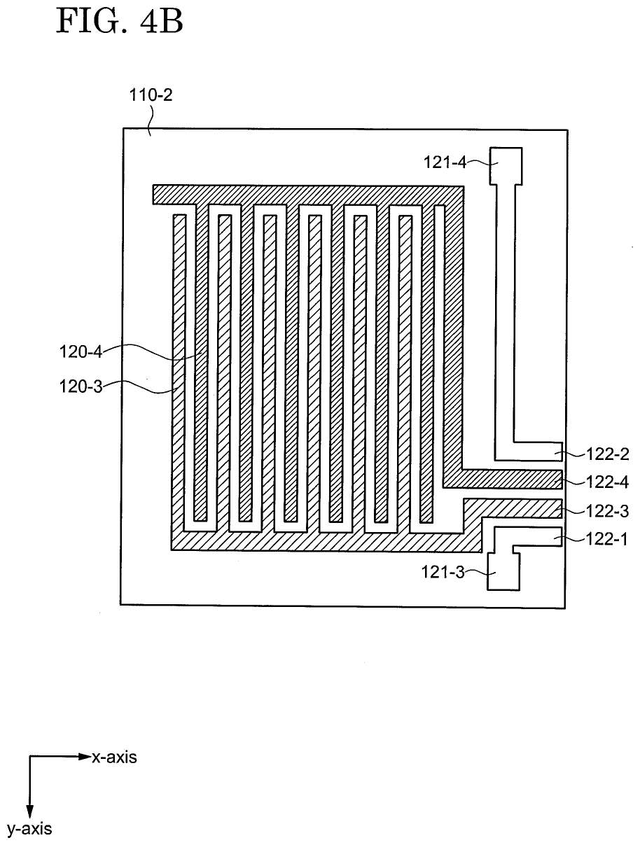

The liquid crystal layer 150 can refract transmitted light or change the polarization state of transmitted light in accordance with the alignment state of the liquid crystal molecules. For example, nematic liquid crystal can be used as the liquid crystal of the liquid crystal layer 150. Although a positive liquid crystal is described as the liquid crystal in the present embodiment, a negative liquid crystal can also be adopted by changing the initial alignment directions of the liquid crystal molecules. Further, the liquid crystal preferably contains a chiral agent that imparts twist to the liquid crystal molecules.

[3. Electrode Pattern of Liquid Crystal Cell 100]Each of FIGS. 4A and 4B is a schematic plan view showing an electrode pattern of the liquid crystal cell 100 included in the optical element 10 of the lighting device 1 according to an embodiment of the present invention. Specifically, FIG. 4A is a plan view showing an electrode pattern formed on the first substrate 110-1 of the first liquid crystal cell 100-1, and FIG. 4B is a plan view showing an electrode pattern formed on the second substrate 110-2 of the first liquid crystal cell 100-1. The first substrate 110-1 and the second substrate 110-2 are bonded to each other such that the electrode pattern shown in FIG. 4A and the electrode pattern shown in FIG. 4B face each other.

As shown in FIG. 4A, a first connection pad 121-1 and a second connection pad 121-2 are provided on the first substrate 110-1. The plurality of first transparent electrodes 120-1 are electrically connected to the first connection pad 121-1. The plurality of second transparent electrodes 120-2 are electrically connected to the second connection pad 121-2.

As shown in FIG. 4B, a third connection pad 121-3, a fourth connection pad 121-4, a first terminal 122-1, a second terminal 122-2, a third terminal 122-3, and a fourth terminal 122-4 are provided on the second substrate 110-2. The third transparent electrodes 120-3 are electrically connected to the third terminal 122-3. The fourth transparent electrodes 120-4 are electrically connected to the fourth terminal 122-4. The third connection pad 121-3 is electrically connected to the first terminal 122-1. The fourth connection pad 121-4 is electrically connected to the second terminal 122-2.

When the first substrate 110-1 and the second substrate 110-2 are bonded to each other, the first connection pad 121-1 and the second connection pad 121-2 overlap the third connection pad 121-3 and the fourth connection pad 121-4, respectively. Since a conductive electrode is provided between the first connection pad 121-1 and the third connection pad 121-3, the first connection pad 121-1 and the third connection pad 121-3 are electrically connected via the conductive electrode. Similarly, since a conductive electrode is provided between the second connection pad 121-2 and the fourth connection pad 121-4, the second connection pad 121-2 and the fourth connection pad 121-4 are electrically connected via the conductive electrode. Therefore, the first transparent electrode 120-1 and the second transparent electrode 120-2 on the first substrate 110-1 are electrically connected to the first terminal 122-1 and the second terminal 122-2, respectively.

The electrode pattern of the second liquid crystal cell 100-2 is the same as that of the first liquid crystal cell 100-1. The configurations of the electrode patterns of the third liquid crystal cell 100-3 and the fourth liquid crystal cell 100-4 are similar to that of the first liquid crystal cell 100-1, except that the extending direction of the transparent electrode 120 differs by 90 degrees.

The first terminal 122-1 to the fourth terminal 122-4 on the second substrate 110-2 are exposed from the first substrate 110-1 in the liquid crystal cell 100. In each of the first liquid crystal cell 100-1 to the fourth liquid crystal cell 100-4, the exposed first terminal 122-1 to the fourth terminal 122-4 are provided with the FPCs 170 (see FIG. 1).

The first output channel CH1 to the fourth output channel CH4 are electrically connected to the first terminal 122-1 to the fourth terminal 122-4 of the first liquid crystal cell 100-1 via the FPCs 170. The fifth output channel CH5 to the eighth output channel CH8 are electrically connected to the first terminal 122-1 to the fourth terminal 122-4 of the second liquid crystal cell 100-2 via the FPCs 170. The ninth output channel CH9 to the twelfth output channel CH12 are electrically connected to the first terminal 122-1 to the fourth terminal 122-4 of the third liquid crystal cell 100-3 via the FPCs 170. The thirteenth output channel CH13 to the sixteenth output channel CH16 are electrically connected to the first terminal 122-1 to the fourth terminal 122-4 of the fourth liquid crystal cell 100-4 via the FPCs 170. Therefore, the control device 30 can input the voltage signals to each of the first transparent electrode 120-1 to the fourth transparent electrode 120-4 of the liquid crystal cell 100 via the FPCs 170 to control the optical element 10.

### [4. Optical Characteristics of Liquid Crystal Cell 100]

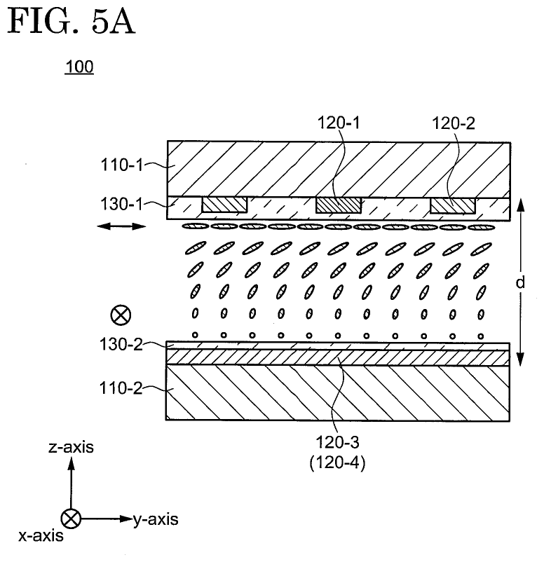

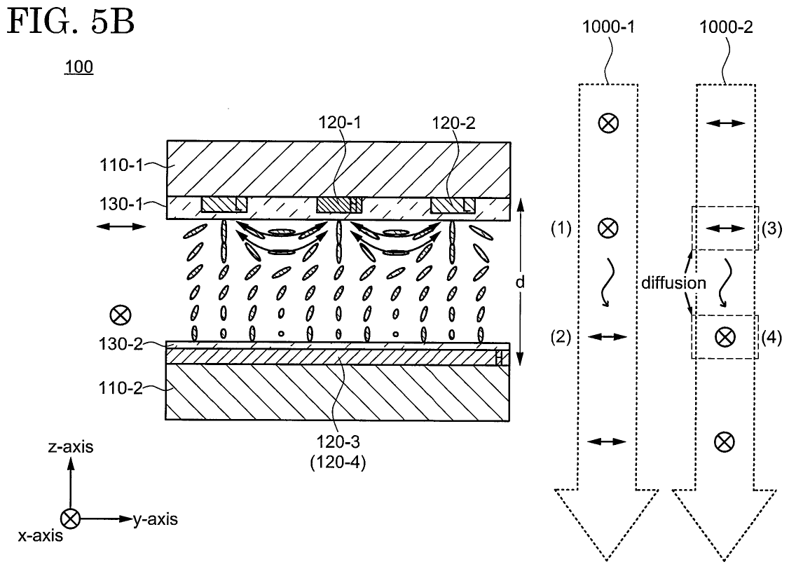

Each of FIGS. 5A and 5B is a schematic diagram illustrating optical characteristics of the liquid crystal cell 100 included in the optical element 10 of the lighting device 1 according to an embodiment of the present invention. Specifically, FIG. 5A shows the liquid crystal cell 100 in a state where no voltage is applied to the transparent electrodes 120, and FIG. 5B shows the liquid crystal cell 100 in a state where voltages are applied to the transparent electrodes 120.

As shown in FIG. 5A, the liquid crystal molecules on the first substrate 110-1 side of the liquid crystal layer 150 are aligned in the y-axis direction, and the liquid crystal molecules on the second substrate 110-2 side of the liquid crystal layer 150 are aligned in the x-axis direction. Therefore, when no voltage is applied to any of the first transparent electrode 120-1 to the fourth transparent electrode 120-4, the liquid crystal molecules in the liquid crystal layer 150 are aligned so as to be twisted 90 degrees along the c-axis direction as they move from the first substrate 110-1 to the second substrate 110-2. Further, the polarization plane (the direction of the polarization axis or the polarization component) of the light passing through the liquid crystal layer 150 is rotated 90 degrees according to the alignment directions of the liquid crystal molecules. That is, the light passing through the liquid crystal layer 150 (more specifically, the polarization component of the transmitted light) has optical rotation.

On the other hand, when voltages are applied so that a potential difference is generated between two adjacent transparent electrodes 120, an electric field (hereinafter referred to as a “lateral electric field”) is generated between the two adjacent transparent electrodes 120, and the alignment state of the liquid crystal molecules changes. As shown in FIG. 5B, the liquid crystal molecules in the liquid crystal layer 150 are aligned so as to be twisted 90 degrees along the c-axis direction from the first substrate 110-1 to the second substrate 110-2, while the liquid crystal molecules closer to the first substrate 110-1 are aligned in a convex arc shape with respect to the first substrate 110-1 by the lateral electric field between the first transparent electrode 120-1 and the second transparent electrode 120-2, and the liquid crystal molecules closer to the second substrate 110-2 are aligned in a convex arc shape with respect to the second substrate 110-2 by the lateral electric field between the third transparent electrode 120-3 and the fourth transparent electrode 120-4. The liquid crystal molecules aligned on the convex arc have a refractive index distribution, and light having the same polarization direction as the alignment direction of the liquid crystal molecules is diffused. In addition, since the cell gap d, which is the distance between the first substrate 110-1 and the second substrate 110-2, is sufficiently larger than the distance between two adjacent transparent electrodes (for example, 10 μm≤d≤30 μm, preferably 10 μm≤d≤30 μm, and more preferably 15 μm≤d≤25 μm), the electric field formed between the transparent electrodes 120 does not have much effect on the liquid crystal molecules located in the vicinity of the center between the first substrate 110-1 and the second substrate 110-2.

The light emitted from the light source 20 includes a polarization component in the x-axis direction (hereinafter, referred to as a “P-polarization component”) and a polarization component in the y-axis direction (hereinafter, referred to as an “S-polarization component”). However, in the following description, the light emitted from the light source 20 is described as being divided into a first light 1000-1 having the P-polarization component and a second light 1000-2 having the S-polarization component, for convenience.

Since the polarization direction of the P-polarized component of the first light 1000-1 incident on the first substrate 110-1 is different from the alignment direction of the liquid crystal molecules on the side of the first substrate 110-1, the first light 1000-1 is not diffused (see (1) in FIG. 5B). Further, the first light 1000-1 is rotated while passing through the liquid crystal layer 150, and the polarization component changes from the P-polarization component to the S-polarization component. Since the polarization direction of the S-polarization component of the first light 1000-1 is different from the alignment direction of the liquid crystal molecules on the side of the second substrate 110-2, the first light 1000-1 is not diffused (see (2) in FIG. 5B).

Since the polarization direction of the S-polarization component of the second light 1000-2 incident on the first substrate 110-1 is the same as the alignment direction of the liquid crystal molecules on the side of the first substrate 110-1, the second light 1000-2 is diffused in the y-axis direction in accordance with the refractive index distribution of the liquid crystal molecules (see (3) in FIG. 5B). Further, the second light 1000-2 is rotated while passing through the liquid crystal layer 150, and the polarization component changes from the S-polarization component to the P-polarization component. Since the polarization direction of the P-polarization component of the second light 1000-2 is the same as the alignment direction of the liquid crystal molecules on the side of the second substrate 110-2, the second light 1000-2 is diffused in the x-axis direction in accordance with the refractive index distribution of the liquid crystal molecules (see (4) in FIG. 5B).

### [5. Control of Light Distribution by Lighting Device 1]

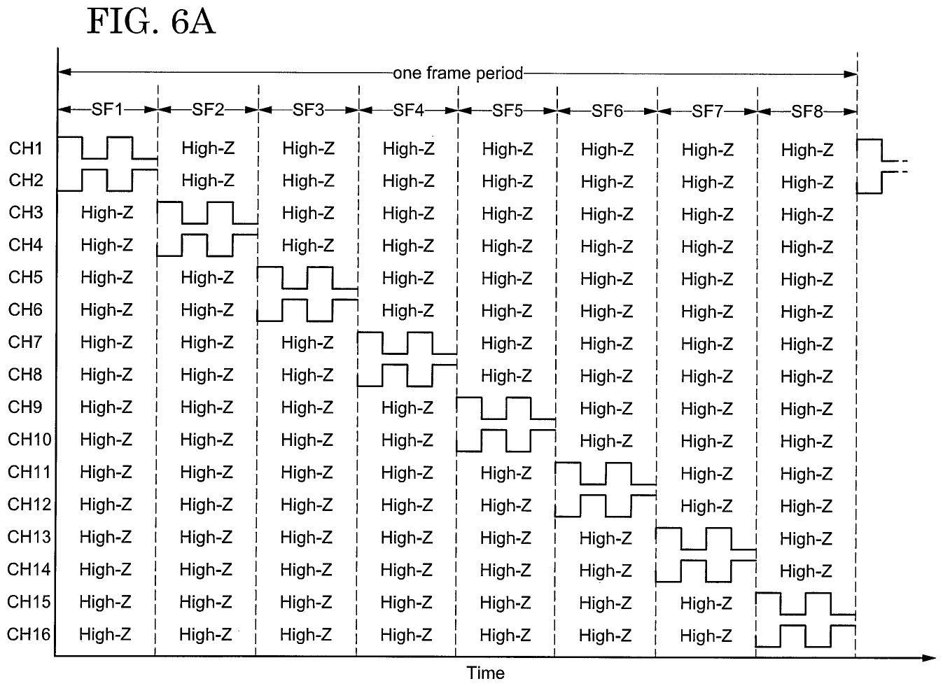

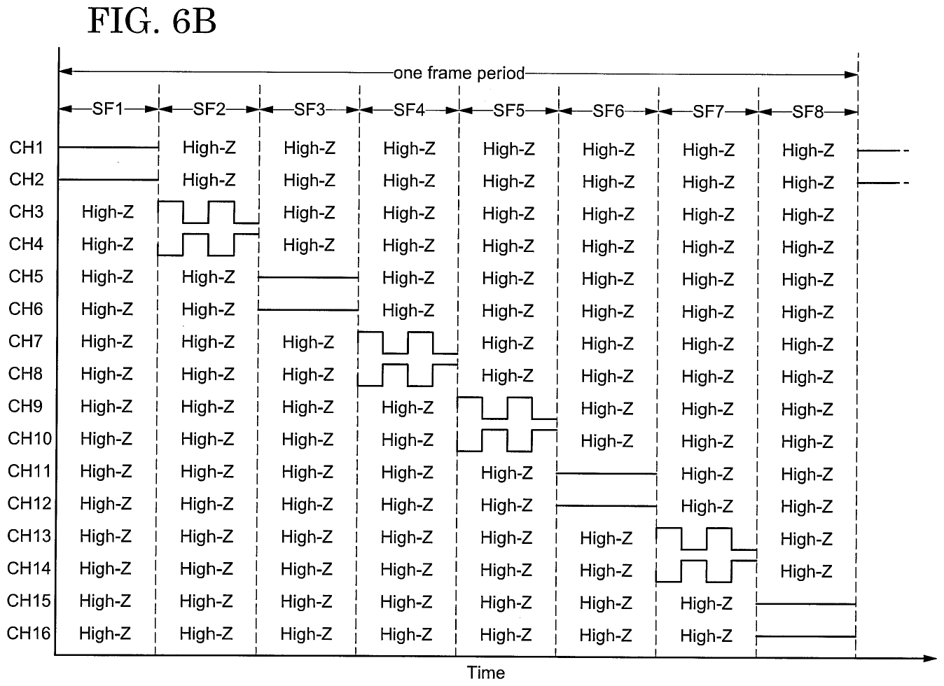

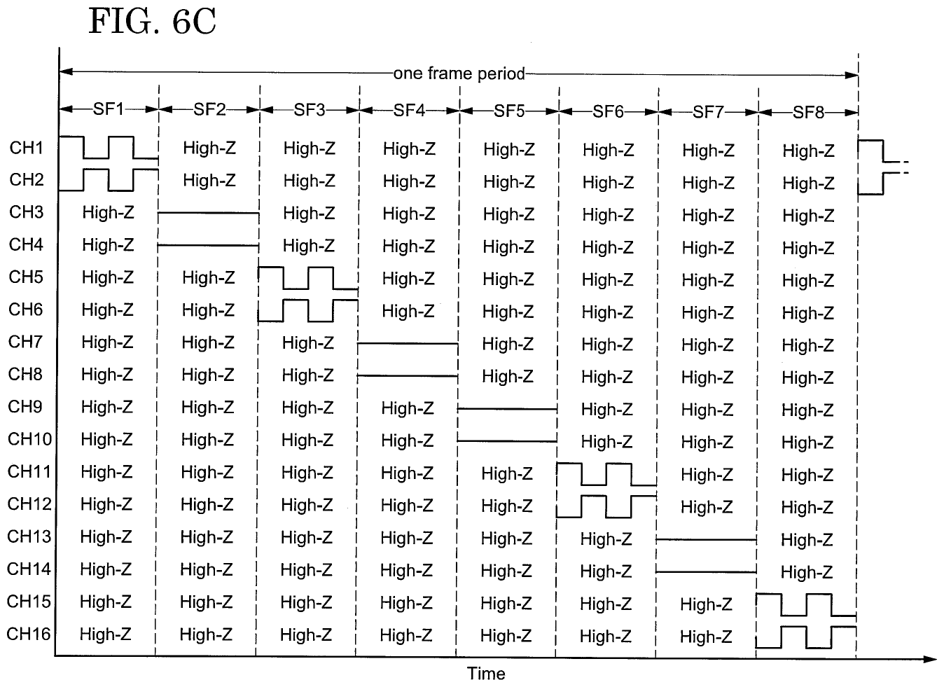

FIGS. 6A to 6C are timing charts showing voltage signals input to the transparent electrodes 120 of the liquid crystal cells 100 to control the light distribution in the lighting device 1 according to an embodiment of the present invention. In the lighting device 1 according to the present embodiment, when predetermined voltage signals are sequentially input to the first transparent electrodes 120-1 to the fourth transparent electrodes 120-4 of each of the first liquid crystal cell 100-1 to the fourth liquid crystal cell 100-4, each liquid crystal cell 100 is driven in a time-division manner. That is, the light distribution of the light passing through the optical element 10 can be controlled in the lighting device 1 by driving the plurality of liquid crystal cells 100 in a time-division manner based on one signal generating circuit section 310. More specifically, in the lighting device 1 according to the present embodiment, the plurality of liquid crystal cells 100 are connected to the switch circuit section 320, and two pairs of the analog conversion circuit 331 and the amplifier circuit 332 are provided between the switch circuit section 320 and the signal generating circuit section 310, and the connection states between the analog conversion circuit 331 and the amplifier circuit 332 and the transparent electrodes 120 of each liquid crystal cell 100 are switched in a time-division manner via the switch circuit section 320, thereby enabling time-division driving of each liquid crystal cell 100. A specific example of time-division driving is described in detail below.

FIG. 6A is a timing chart showing control of the optical element 10 so that the light distribution shape is circular, FIG. 6B is a timing chart showing control of the optical element 10 so that the light distribution shape is a linear shape spreading in the x-axis direction, and FIG. 6C is a timing chart showing control of the optical element 10 so that the light distribution shape is a linear shape spreading in the y-axis direction.

In FIGS. 6A to 6C, the voltage signals output from the first output channel CH1 to the fourth output channel CH4 are input to the first transparent electrode 120-1 to the fourth transparent electrode 120-4 of the first liquid crystal cell 100-1, respectively. The voltage signals output from the fifth output channel CH5 to the eighth output channel CH8 are input to the first transparent electrode 120-1 to the fourth transparent electrode 120-4 of the second liquid crystal cell 100-2, respectively. The voltage signals output from the ninth output channel CH9 to the twelfth output channel CH12 are input to the first transparent electrode 120-1 to the fourth transparent electrode 120-4 of the third liquid crystal cell 100-3, respectively. The voltage signals output from the thirteenth output channel CH13 to the sixteenth output channel CH16 are input to the first transparent electrode 120-1 to the fourth transparent electrode 120-4 of the fourth liquid crystal cell 100-4, respectively.

As shown in FIGS. 6A to 6C, one frame period is divided into eight subframe periods SF (a first subframe period SF1 to an eighth subframe period SF8) in the lighting device 1.

[5-1. Light Distribution having Circular Shape]

As shown in FIG. 6A, in the first subframe period SF1, a first voltage signal having a rectangular wave is output from the first output channel CH1, and a second voltage signal having a rectangular wave is output from the second output channel CH2. The phase of the first voltage signal is reversed to the phase of the second voltage signal. In other words, the phase of the first voltage signal is different from the phase of the second voltage signal by 180 degrees. Meanwhile, the third output channel CH3 to the sixteenth output channel CH16 are in a high impedance state (High-Z).

In the first subframe period SF1, the first voltage signal and the second voltage signal generated by the signal generating circuit section 310 are input to the switch circuit section 320 via the first voltage signal line 330-1 and the second voltage signal line 330-2, respectively. The switch circuit section 320 drives so that the first voltage signal line 330-1 and the second voltage signal line 330-2 are conductive with the first output channel CH1 and the second output channel CH2, respectively. Therefore, in the first subframe period SF1, as described in the above description, the first voltage signal and the second voltage signal are output from the first output channel CH1 and the second output channel CH2, respectively. On the other hand, since the first voltage signal line 330-1 and the second voltage signal line 330-2 are in a non-conductive state with the third output channel CH3 to the sixteenth output channel CH16, the third output channel CH3 to the sixteenth output channel CH16 are in the high impedance state.

Therefore, in the first subframe period SF1, a high voltage or a low voltage is applied to each of the first transparent electrode 120-1 and the second transparent electrode 120-2 of the first liquid crystal cell 100-1. That is, in the first subframe period SF1, a lateral electric field is generated between the first transparent electrode 120-1 and the second transparent electrode 120-2 of the first liquid crystal cell 100-1.

In the second subframe period SF2, a third voltage signal having a rectangular wave and a fourth voltage signal having a rectangular wave generated by the signal generating circuit section 310 are input to the switch circuit section 320 via the first voltage signal line 330-1 and the second voltage signal line 330-2, respectively. Here, the phase of the third voltage signal is reversed to the phase of the fourth voltage signal. The switch circuit section 320 drives so that the first voltage signal line 330-1 and the second voltage signal line 330-2 are conductive with the third output channel CH3 and the fourth output channel CH4, respectively. Therefore, in the second subframe period SF2, the third voltage signal and the fourth voltage signal are output from the third output channel CH3 and the fourth output channel CH4, respectively. On the other hand, since the first voltage signal line 330-1 and the second voltage signal line 330-2 are in a non-conductive state with the first output channel CH1, the second output channel CH2, and the fifth output channel CH5 to the sixteenth output channel CH16, the first output channel CH1, the second output channel CH2, and the fifth output channel CH5 to the sixteenth output channel CH16 are in a high impedance state.

Therefore, in the second subframe period SF2, a high voltage or a low voltage is applied to each of the third transparent electrode 120-3 and the fourth transparent electrode 120-4 of the first liquid crystal cell 100-1. That is, in the second subframe period SF2, a lateral electric field is generated between the third transparent electrode 120-3 and the fourth transparent electrode 120-4 of the first liquid crystal cell 100-1.

In the second subframe period SF2, since the first output channel CH1 and the second output channel CH2 are in the high impedance state, the high voltage or the low voltage applied to the first transparent electrode 120-1 and the second transparent electrode 120-2 of the first liquid crystal cell 100-1 is maintained by the capacitance of the liquid crystal in the liquid crystal layer 150. Therefore, even in the second subframe period SF2, the lateral electric field is maintained between the first transparent electrode 120-1 and the second transparent electrode 120-2 of the first liquid crystal cell 100-1.

The same configuration is applied to the third subframe period SF3 to the eighth subframe period. That is, in the third subframe period SF3 and the fourth subframe period SF4, a lateral electric field is generated between the first transparent electrode 120-1 and the second transparent electrode 120-2 of the second liquid crystal cell 100-2, and between the third transparent electrode 120-3 and the fourth transparent electrode 120-4 of the second liquid crystal cell 100-2. In the fifth subframe period SF5 and the sixth subframe period SF6, a lateral electric field is generated between the first transparent electrode 120-1 and the second transparent electrode 120-2 of the third liquid crystal cell 100-3, and between the third transparent electrode 120-3 and the fourth transparent electrode 120-4 of the third liquid crystal cell 100-3. In the seventh subframe period SF7 and the eighth subframe period SF8, a lateral electric field is generated between the first transparent electrode 120-1 and the second transparent electrode 120-2 of the fourth liquid crystal cell 100-4, and between the third transparent electrode 120-3 and the fourth transparent electrode 120-4 of the fourth liquid crystal cell 100-4.

Even during the third subframe period SF3 to the eighth subframe period SF8, since the output channel CH to which no voltage signal is output is in a high impedance state, the high voltage or the low voltage applied to the transparent electrode 120 is maintained by the capacitance of the liquid crystal in the liquid crystal layer 150.

Therefore, the diffusion characteristics of the first liquid crystal cell 100-1 to the fourth liquid crystal cell 100-4 in one frame period are as shown in Table 1. In each of the first subframe period SF1 to the eighth subframe period SF8, a lateral electric field is controlled to be generated between two adjacent transparent electrodes 120 on one substrate 110 side of the liquid crystal cell 100. However, since the high voltage or the low voltage applied to the transparent electrode 120 is maintained by the capacitance of the liquid crystal of the liquid crystal layer 150, the first liquid crystal cell 100-1 to the fourth liquid crystal cell 100-4 have the diffusion characteristics shown in Table 1 in one frame period. In this case, each of the P-polarization component and the S-polarization component of the light emitted from the light source 20 is diffused in the x-axis direction and the y-axis direction by the optical element 10. Accordingly, the light emitted from the light source 20 is controlled by the optical element 10 to have a light distribution having a circular shape. In addition, when the magnitudes of the high voltage and the low voltage applied to each transparent electrode 120 are changed, it is also possible to control the light distribution to have an elliptical shape.

TABLE 1

| | | Light emitted from | |
|---|---|---|---|
| | | light source 20 | |
| | | P-polarization | S-polarization |
| | | component | component |
| First Liquid | First substrate | No diffusion | Diffusion |
| Crystal Cell | side | | along y-axis |
| | Second substrate | No diffusion | Diffusion |
| | side | | along x-axis |
| Second Liquid | First substrate | Diffusion | No diffusion |
| Crystal Cell | side | along y-axis | |
| | Second substrate | Diffusion | No diffusion |
| | side | along x-axis | |
| Third Liquid | First substrate | Diffusion | No diffusion |
| Crystal Cell | side | along x-axis | |
| | Second substrate | Diffusion | No diffusion |
| | side | along y-axis | |
| Fourth Liquid | First substrate | No diffusion | Diffusion |
| Crystal Cell | side | | along x-axis |
| | Second substrate | No diffusion | Diffusion |
| | side | | along y-axis |

The frequency of one frame period is 30 Hz to 120 Hz, and preferably 60 Hz. When the frequency of one frame period is in the above range, the voltage applied to the transparent electrode 120 can be maintained by the capacitance of the liquid crystal of the liquid crystal layer 150.

[5-2. Light Distribution with Linear Shape Spreading in X-Axis Direction]

As shown in FIG. 6B, in the first subframe period SF1, the first voltage signal and the second voltage signal having an intermediate voltage (a voltage between a high voltage and a low voltage) generated by the signal generating circuit section 310 are input to the switch circuit section 320 via the first voltage signal line 330-1 and the second voltage signal line 330-2, respectively. The intermediate voltage is a fixed voltage, and the phase of the first voltage signal is the same as the phase of the second voltage signal. The switch circuit section 320 drives so that the first voltage signal line 330-1 and the second voltage signal line 330-2 are conductive with the first output channel CH1 and the second output channel CH2, respectively. Therefore, in the first subframe period SF1, the first voltage signal and the second voltage signal are output from the first output channel CH1 and the second output channel CH2, respectively. On the other hand, since the first voltage signal line 330-1 and the second voltage signal line 330-2 are in a non-conductive state with the third output channel CH3 to the sixteenth output channel CH16, the third output channel CH3 to the sixteenth output channel CH16 are in a high impedance state.

Therefore, in the first subframe period SF1, the intermediate voltage is applied to each of the first transparent electrode 120-1 and the second transparent electrode 120-2 of the first liquid crystal cell 100-1. In this case, since the first transparent electrode 120-1 and the second transparent electrode 120-2 are at the same potential, no lateral electric field is generated between the first transparent electrode 120-1 and the second transparent electrode 120-2.

Since the second subframe period SF2 shown in FIG. 6B is similar to the second subframe period SF2 shown in FIG. 6A, a description thereof is omitted.

Therefore, in the second subframe period SF2, the high voltage or the low voltage is applied to each of the third transparent electrode 120-3 and the fourth transparent electrode 120-4 of the first liquid crystal cell 100-1. That is, in the second subframe period SF2, a lateral electric field is generated between the third transparent electrode 120-3 and the fourth transparent electrode 120-4 of the first liquid crystal cell 100-1.

In addition, In the second subframe period SF2, since the first output channel CH1 and the second output channel CH2 are in a high impedance state, the intermediate voltage applied to the first transparent electrode 120-1 and the second transparent electrode 120-2 of the first liquid crystal cell 100-1 is maintained by the capacitance of the liquid crystal in the liquid crystal layer 150. Therefore, in the first subframe period SF1 and the second subframe period SF2, the lateral electric field is generated only between the third transparent electrode 120-3 and the fourth transparent electrode 120-4 of the first liquid crystal cell 100-1.

The same configuration is applied to the third subframe period SF3 to the eighth subframe period. That is, in the third subframe period SF3 and the fourth subframe period SF4, a lateral electric field is generated only between the third transparent electrode 120-3 and the fourth transparent electrode 120-4 of the second liquid crystal cell 100-2. In the fifth subframe period SF5 and the sixth subframe period SF6, a lateral electric field is generated only between the first transparent electrode 120-1 and the second transparent electrode 120-2 of the third liquid crystal cell 100-3. In the seventh subframe period SF7 and the eighth subframe period SF8, a lateral electric field is generated only between the first transparent electrode 120-1 and the second transparent electrode 120-2 of the fourth liquid crystal cell 100-4.

Even during the third subframe period SF3 to the eighth subframe period SF8, since the output channel CH to which no voltage signal is output is in a high impedance state, the high voltage, the low voltage, or the intermediate voltage applied to the transparent electrode 120 is maintained by the capacitance of the liquid crystal in the liquid crystal layer 150.

Therefore, the diffusion characteristics of the first liquid crystal cell 100-1 to the fourth liquid crystal cell 100-4 in one frame period are as shown in Table 2. In each of the second subframe period SF2, the fourth subframe period SF4, the fifth subframe period SF5, and the seventh subframe period SF7, a lateral electric field is controlled to be generated between two adjacent transparent electrodes 120 on one substrate 110 side of the liquid crystal cell 100. In each of the first subframe period SF1, the third subframe period SF3, the sixth subframe period SF6, and the eighth subframe period SF8, the intermediate voltage is controlled to be applied to the two transparent electrodes 120 on the other substrate 110 side of the liquid crystal cell 100. However, since the high voltage, the low voltage, or the intermediate voltage applied to the transparent electrode 120 is maintained by the capacitance of the liquid crystal in the liquid crystal layer 150, the first liquid crystal cell 100-1 to the fourth liquid crystal cell 100-4 have the diffusion characteristics shown in Table 2 during one frame period. In this case, each of the P-polarization component and the S-polarization component of the light emitted from the light source 20 is diffused only in the x-axis direction by the optical element 10. Accordingly, the light emitted from the light source 20 is controlled by the optical element 10 to have a light distribution having a linear shape spreading in the x-axis direction.

TABLE 2

| | | Light emitted from | |
|---|---|---|---|
| | | light source 20 | |
| | | P-polarization | S-polarization |
| | | component | component |
| First Liquid | First substrate | No diffusion | No diffusion |
| Crystal Cell | side | | |
| | Second substrate | No diffusion | Diffusion |
| | side | | along x-axis |
| Second Liquid | First substrate | No diffusion | No diffusion |
| Crystal Cell | side | | |
| | Second substrate | Diffusion | No diffusion |
| | side | along x-axis | |
| Third Liquid | First substrate | Diffusion | No diffusion |
| Crystal Cell | side | along x-axis | |
| | Second substrate | No diffusion | No diffusion |
| | side | | |
| Fourth Liquid | First substrate | No diffusion | Diffusion |
| Crystal Cell | side | | along x-axis |
| | Second substrate | No diffusion | No diffusion |
| | side | | |

Although the high voltage, the low voltage, and the intermediate voltage are +15 V, −15 V, and 0 V, respectively, the high voltage, the low voltage, and the intermediate voltage are not limited thereto. The high voltage, the low voltage, and the intermediate voltage may be +30 V, 0 V, and +15 V, respectively. In addition, the above voltage values are merely examples and are not limited thereto.

[5-3. Light Distribution with Linear Shape Spreading in Y-Axis Direction]

Since the first subframe period SF1 shown in FIG. 6C is similar to the first subframe period SF1 shown in FIG. 6A, a description thereof is omitted.

Therefore, in the first subframe period SF1, the high voltage or the low voltage is applied to each of the first transparent electrode 120-1 and the second transparent electrode 120-2 of the first liquid crystal cell 100-1. That is, in the first subframe period SF1, a lateral electric field is generated between the first transparent electrode 120-1 and the second transparent electrode 120-2 of the first liquid crystal cell 100-1.

As shown in FIG. 6C, in the second subframe period SF2, the third voltage signal and the fourth voltage signal having the intermediate voltage generated by the signal generating circuit section 310 are input to the switch circuit section 320 via the first voltage signal line 330-1 and the second voltage signal line 330-2, respectively. The switch circuit section 320 drives so that the first voltage signal line 330-1 and the second voltage signal line 330-2 are conductive with the third output channel CH3 and the fourth output channel CH4, respectively. Therefore, in the second subframe period SF2, the third voltage signal and the fourth voltage signal are output from the third output channel CH3 and the fourth output channel CH4, respectively. On the other hand, since the first voltage signal line 330-1 and the second voltage signal line 330-2 are in a non-conductive state with the first output channel CH1, the second output channel CH2, and the fifth output channel CH5 to the sixteenth output channel CH16, the first output channel CH1, the second output channel CH2, and the fifth output channel CH5 to the sixteenth output channel CH16 are in a high impedance state.

Therefore, in the second subframe period SF2, the intermediate voltage is applied to each of the third transparent electrode 120-3 and the fourth transparent electrode 120-4 of the first liquid crystal cell 100-1. In this case, since the third transparent electrode 120-3 and the fourth transparent electrode 120-4 are at the same potential, no lateral electric field is generated between the third transparent electrode 120-3 and the fourth transparent electrode 120-4.

In addition, since the first output channel CH1 and the second output channel CH2 are in a high impedance state in the second subframe period SF2, the high voltage or the low voltage applied to the first transparent electrode 120-1 and the second transparent electrode 120-2 of the first liquid crystal cell 100-1 is maintained by the capacitance of the liquid crystal in the liquid crystal layer 150. Therefore, in the first subframe period SF1 and the second subframe period SF2, a lateral electric field is generated only between the first transparent electrode 120-1 and the second transparent electrode 120-2 of the first liquid crystal cell 100-1.

The same configuration is applied to the third subframe period SF3 to the eighth subframe period SF8. That is, in the third subframe period SF3 and the fourth subframe period SF4, a lateral electric field is generated only between the first transparent electrode 120-1 and the second transparent electrode 120-2 of the second liquid crystal cell 100-2. In the fifth subframe period SF5 and the sixth subframe period SF6, a lateral electric field is generated only between the third transparent electrode 120-3 and the fourth transparent electrode 120-4 of the third liquid crystal cell 100-3. In the seventh subframe period SF7 and the eighth subframe period SF8, a lateral electric field is generated only between the third transparent electrode 120-3 and the fourth transparent electrode 120-4 of the fourth liquid crystal cell 100-4.

Even during the third subframe period SF3 to the eighth subframe period SF8, since the output channel CH to which no voltage signal is output is in a high impedance state, the high voltage, the low voltage, or the intermediate voltage applied to the transparent electrode 120 is maintained by the capacitance of the liquid crystal in the liquid crystal layer 150.

Therefore, the diffusion characteristics of the first liquid crystal cell 100-1 to the fourth liquid crystal cell 100-4 in one frame period are as shown in Table 3. In each of the first subframe period SF1, the third subframe period SF3, the sixth subframe period SF6, and the eighth subframe period SF8, a lateral electric field is controlled to be generated between two adjacent transparent electrodes 120 on one substrate 110 side of the liquid crystal cell 100. In each of the second subframe period SF2, the fourth subframe period SF4, the fifth subframe period SF5, and the seventh subframe period SF7, the intermediate voltage is controlled to be applied to the two transparent electrodes 120 on the other substrate 110 side of the liquid crystal cell 100. However, since the high voltage, the low voltage, or the intermediate voltage applied to the transparent electrode 120 are maintained by the capacitance of the liquid crystal in the liquid crystal layer 150, the first liquid crystal cell 100-1 to the fourth liquid crystal cell 100-4 have the diffusion characteristics shown in Table 3 during one frame period. In this case, each of the P-polarization component and the S-polarization component of the light emitted from the light source 20 is diffused only in the y-axis direction by the optical element 10. Accordingly, the light emitted from the light source 20 is controlled by the optical element 10 to have a light distribution having a linear shape spreading in the y-axis direction.

TABLE 3

| | | Light emitted from | |
|---|---|---|---|
| | | light source 20 | |
| | | P-polarization | S-polarization |
| | | component | component |
| First Liquid | First substrate | No diffusion | Diffusion |
| Crystal Cell | side | | along y-axis |
| | Second substrate | No diffusion | No diffusion |
| | side | | |
| Second Liquid | First substrate | Diffusion | No diffusion |
| Crystal Cell | side | along y-axis | |
| | Second substrate | No diffusion | No diffusion |
| | side | | |
| Third Liquid | First substrate | No diffusion | No diffusion |
| Crystal Cell | side | | |
| | Second substrate | Diffusion | No diffusion |
| | side | along y-axis | |
| Fourth Liquid | First substrate | No diffusion | No diffusion |
| Crystal Cell | side | | |
| | Second substrate | No diffusion | Diffusion |
| | side | | along y-axis |

As described above, one frame is divided into a plurality of subframe periods SF in the control of the light distribution by the lighting device 1 according to the present embodiment. In each subframe period SF, the output channel of the switch circuit section 320 is switched according to two voltage signals input from the signal generating circuit section 310 to a pair of voltage signal lines 330 (the first voltage signal line 330-1 and the second voltage signal line), and two voltage signals are input to each of the two adjacent transparent electrodes 120. Therefore, the number of voltage signal lines 330 can be reduced more than the number of transparent electrodes 120, and as a result, the number of DACs and AMPs can be reduced. Accordingly, in the lighting device 1, the control device 30 can be made smaller and the manufacturing cost can be reduced.

### Second Embodiment

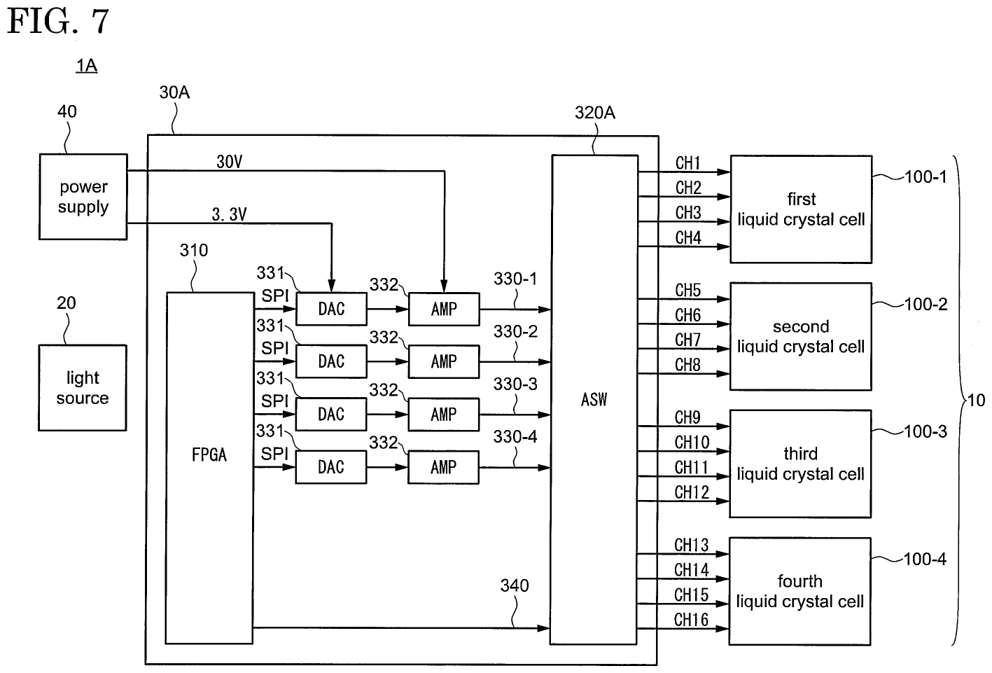

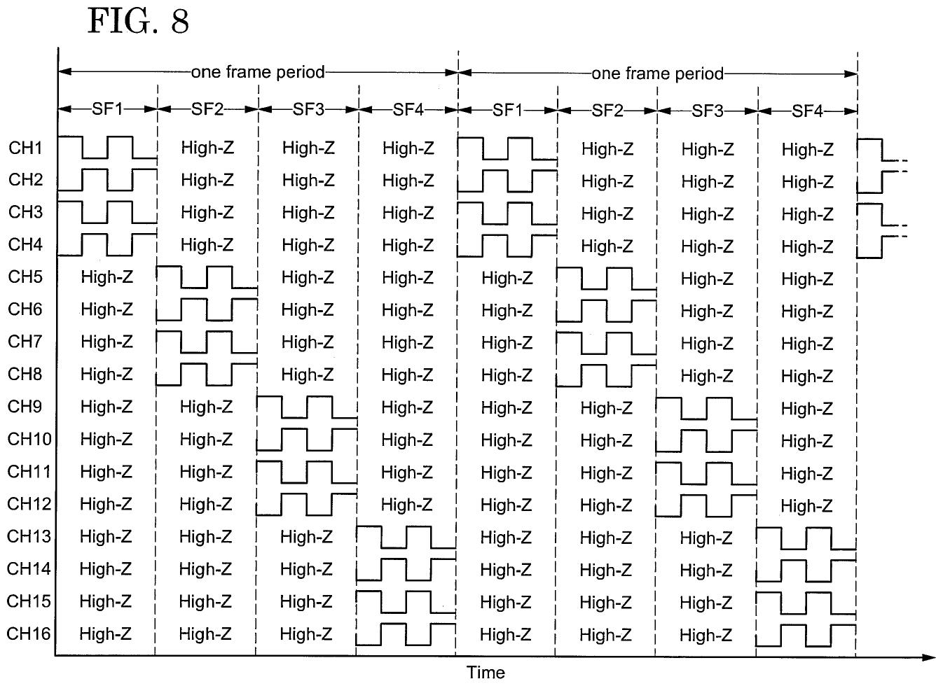

A lighting device 1A according to an embodiment of the present invention is described with reference to FIGS. 7 and 8. When a configuration of the lighting device 1A is similar to that of the lighting device 1, the description of the configuration of the lighting device 1A may be omitted.

### [1. Configuration of Lighting Device 1A]

FIG. 7 is a block diagram showing a configuration of the lighting device 1A according to an embodiment of the present invention. As shown in FIG. 7, the lighting device 1A includes the optical element 10, the light source 20, a control device 30A, and the power supply 40. The control device 30A includes the signal generating circuit section 310, a switch circuit section 320A, the first voltage signal line 330-1, the second voltage signal line 330-2, a third voltage signal line 330-3, a fourth voltage signal line 330-4, and the timing control signal line 340.

The signal generating circuit section 310 and the switch circuit section 320A are connected to each other via a first voltage signal line 330-1 to a fourth voltage signal line 330-4. Therefore, four voltage signals of the plurality of voltage signals generated by the signal generating circuit section 310 are input to the switch circuit section 320 via the first voltage signal line 330-1 to the fourth voltage signal line 330-4.

The switch circuit section 320A can drive based on the timing control signal so that the first voltage signal line 330-1 to the fourth voltage signal line 330-4 are conductive with any four of the first output channel CH1 to the sixteenth output channel CH16. For example, the switch circuit section 320A can drive based on the timing control signal so that the first voltage signal line 330-1 to the fourth voltage signal line 330-4 are conductive with the first output channel CH1 to the fourth output channel CH4. In addition, at this time, the first voltage signal line 330-1 to the fourth voltage signal line 330-4 and the fifth output channel CH5 to the sixteenth output channel CH16 are in a non-conductive state. That is, each of the fifth output channel CH5 to the sixteenth output channel CH16 is in a high impedance state.

### [2. Control of Light Distribution by Lighting Device 1A]

FIG. 8 is a timing chart showing voltage signals input to the transparent electrodes 120 of the liquid crystal cells 100 to control the light distribution in the lighting device 1A according to an embodiment of the present invention. In the lighting device 1A according to the present embodiment, when predetermined voltage signals are sequentially input to the first transparent electrodes 120-1 to 120-4 of each of the first liquid crystal cell 100-1 to the fourth liquid crystal 100-4, the liquid crystal cells 100 is driven in a time-division manner. That is, the light distribution of the light passing through the optical element 10 in the lighting device 1A can be controlled by driving the plurality of liquid crystal cells 100 in a time-division manner based on one signal generating circuit section 310. More specifically, in the lighting device 1A according to the present embodiment, the plurality of liquid crystal cells 100 are connected to the switch circuit section 320A, and four pairs of the analog conversion circuit 331 and the amplifier circuit 332 are provided between the switch circuit section 320A and the signal generating circuit section 310, and the connection states between the analog conversion circuit 331 and the amplifier circuit 332 and the transparent electrodes 120 of each liquid crystal cell 100 are switched in a time-division manner via the switch circuit section 320A, thereby enabling time-division driving of each liquid crystal cell 100. A specific example of time-division driving is described in detail below.

FIG. 8 is a timing chart showing control of the optical element 10 so that the light distribution shape is a circular shape. However, in the lighting device 1A, the light distribution shape controlled by the optical element 10 is not limited thereto. In the lighting device 1A similar to the lighting device 1, a light distribution shape having a linear shape spreading in the x-axis direction or the y-axis direction is also possible.

As shown in FIG. 8, one frame period is divided into four subframe periods (a first subframe period SF1 to a fourth subframe period SF4) in the lighting device 1A.

In the first subframe period SF1, the first voltage signal to the fourth voltage signal having a rectangular wave generated by the signal generating circuit section 310 are input to the switch circuit section 320A via the first voltage signal line 330-1 to the fourth voltage signal line 330-4, respectively. Here, the phase of the first voltage signal is reversed to the phase of the second voltage signal, and the phase of the third voltage signal is reversed to the phase of the fourth voltage signal. The switch circuit section 320 drives so that the first voltage signal line 330-1 to the fourth voltage signal line 330-1 are conductive with the first output channel CH1 to the fourth output channel CH4, respectively. Therefore, in the first subframe period SF1, the first voltage signal to the fourth voltage signal are output from the first output channel CH1 to the fourth output channel CH4, respectively. On the other hand, since the first voltage signal line 330-1 to the fourth voltage signal line 330-4 and the fifth output channel CH5 to the sixteenth output channel CH16 are in a non-conductive state, the fifth output channel CH5 to the sixteenth output channel CH16 are in a high impedance state.

Therefore, in the first subframe period SF1, the high voltage or the low voltage is applied to each of the first transparent electrode 120-1 to the fourth transparent electrode 120-4 of the first liquid crystal cell 100-1. That is, in the first subframe period SF1, a lateral electric field is generated between the first transparent electrode 120-1 and the second transparent electrode 120-2 of the first liquid crystal cell 100-1, and between the third transparent electrode 120-3 and the fourth transparent electrode 120-4 of the first liquid crystal cell 100-1.

In the second subframe period, the fifth voltage signal to the eighth voltage signal having a rectangular wave generated by the signal generating circuit section 310 are input to the switch circuit section 320A via the first voltage signal line 330-1 to the fourth voltage signal line 330-4, respectively. Here, the phase of the fifth voltage signal is reversed to the phase of the sixth voltage signal, and the phase of the seventh voltage signal is reversed to the phase of the eighth voltage signal. The switch circuit section 320 drives so that the first voltage signal line 330-1 to the fourth voltage signal line 330-4 are conductive with the fifth output channel CH 5 to eighth output channel CH8, respectively. Therefore, in the second subframe period SF2, the fifth voltage signal to the eighth voltage signal are output from the fifth output channel CH5 to the eighth output channel CH8. On the other hand, since the first voltage signal line 330-1 to the fourth voltage signal line 330-4 and the first output channel CH1 to the fourth output channel CH4 and the ninth output channel CH9 to the sixteenth output channel CH16 are in a non-conductive state, the first output channel CH1 to the fourth output channel CH4 and the ninth output channel CH9 to the sixteenth output channel CH16 are in a high impedance state.

Therefore, in the second subframe period SF2, the high voltage or the low voltage is applied to each of the first transparent electrode 120-1 to the fourth transparent electrode 120-4 of the second liquid crystal cell 100-2. That is, in the second subframe period SF2, a lateral electric field is generated between the first transparent electrode 120-1 and the second transparent electrode 120-2 of the second liquid crystal cell 100-2, and between the third transparent electrode 120-3 and the fourth transparent electrode 120-4 of the second liquid crystal cell 100-2.

In addition, In the second subframe period SF2, since the first output channel CH1 to the fourth output channel CH4 are in the high impedance state, the high voltage or the low voltage applied to the first transparent electrode 120-1 to the fourth transparent electrode 120-4 of the first liquid crystal cell 100-1 is maintained by the capacitance of the liquid crystal in the liquid crystal layer 150. Therefore, even in the second subframe period SF2, a lateral electric field is maintained between the first transparent electrode 120-1 and the second transparent electrode 120-2 of the first liquid crystal cell 100-1, and between the third transparent electrode 120-3 and the fourth transparent electrode 120-4 of the first liquid crystal cell 100-1.

The same configuration is applied to the third subframe period SF3 and the fourth subframe period SF4. That is, in the third subframe period SF3, a lateral electric field is generated between the first transparent electrode 120-1 and the second transparent electrode 120-2 of the third liquid crystal cell 100-3, and between the third transparent electrode 120-3 and the fourth transparent electrode 120-4 of the third liquid crystal cell 100-3. In the fourth subframe period SF4, a lateral electric field is generated between the first transparent electrode 120-1 and the second transparent electrode 120-2 of the fourth liquid crystal cell 100-4, and between the third transparent electrode 120-3 and the fourth transparent electrode 120-4 of the fourth liquid crystal cell 100-4.

Even in the third subframe period SF3 and the fourth subframe period SF4, since the output channel CH from which no voltage signal is output is in a high impedance state, the high voltage or the low voltage applied to the transparent electrode 120 is maintained by the capacitance of the liquid crystal in the liquid crystal layer 150.

Therefore, the diffusion characteristics of the first liquid crystal cell 100-1 to the fourth liquid crystal cell 100-4 in one frame period are as shown in Table 1. In this case, each of the P-polarization component and the S-polarization component of the light emitted from the light source 20 is diffused in the x-axis direction and the y-axis direction by the optical element 10. Accordingly, the light emitted from the light source 20 is controlled by the optical element 10 to have a light distribution having a circular shape. In addition, when the magnitudes of the high voltage and the low voltage applied to each transparent electrode 120 are changed, it is also possible to control the light distribution to have an elliptical shape.

As described above, one frame is divided into a plurality of subframe periods SF in the control of the light distribution by the lighting device 1A according to the present embodiment. In each subframe period SF, the output channel of the switch circuit section 320 is switched according to two voltage signals input from the signal generating circuit section 310 to two pairs of voltage signal lines 330 (the first voltage signal line 330-1 to the fourth voltage signal line), and two voltage signals are input to each of two adjacent transparent electrodes 120. In this way, even when the light distribution is controlled using multiple pairs of voltage signal lines 330, the number of voltage signal lines 330 can be reduced more than the number of transparent electrodes 120, and as a result, the number of DACs and AMPs can be reduced. Accordingly, in the lighting device 1A, the control device 30A can be made smaller and the manufacturing cost can be reduced.

### Third Embodiment

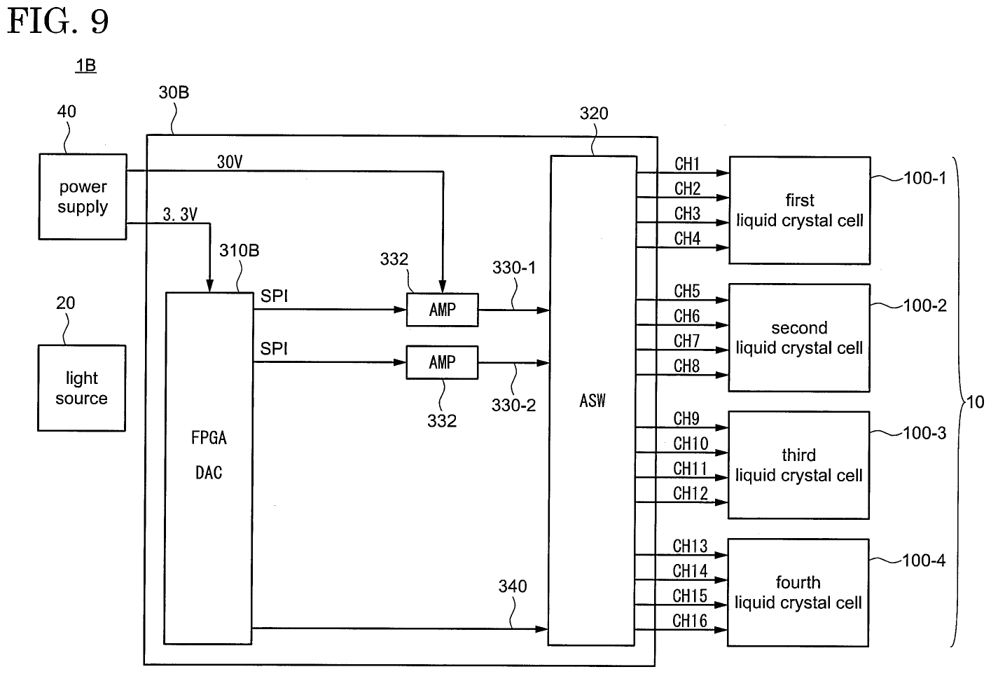

A lighting device 1B according to an embodiment of the present invention is described with reference to FIG. 9. When a configuration of the lighting device 1B is similar to that of the lighting device 1, the description of the configuration of the lighting device 1B may be omitted.

FIG. 9 is a block diagram showing a configuration of a lighting device 1B according to an embodiment of the present invention. As shown in FIG. 9, the lighting device 1B includes the optical element 10, the light source 20, a control device 30B, and the power supply 40. The control device 30B includes a signal generating circuit section 310B, the switch circuit section 320, the first voltage signal line 330-1, the second voltage signal line 330-2, and the timing control signal line 340.

The signal generating circuit section 310B includes a DAC. That is, the signal generating circuit section 310B integrates the DAC, and the voltage signal output from the signal generating circuit section 310B is a digital signal. Therefore, each of the first voltage signal line 330-1 and the second voltage signal line 330-2 does not include a DAC.

As described above, the lighting device 1B according to the present embodiment does not include a DAC that occupies a large area in each of the first voltage signal line 330-1 and the second voltage signal line 330-2. Therefore, in the lighting device 1B, the number of DACs can be reduced, and as a result, the manufacturing cost can be reduced.

Within the scope of the present invention, those skilled in the art may conceive of examples of changes and modifications, and it is understood that these examples of changes and modifications are also included within the scope of the present invention. For example, additions, deletions, or design changes of constituent elements, or additions, omissions, or changes to conditions of steps as appropriate based on the respective embodiments described above are also included within the scope of the present invention as long as the gist of the present invention is provided.

Further, other effects which differ from those brought about by each embodiment, but which are apparent from the description herein or which can be readily predicted by those skilled in the art, are naturally understood to be brought about by the present invention.

What is claimed is:

1. A lighting device, comprising:
a light source;
an optical element comprising a first liquid crystal cell and a second liquid crystal cell, and configured to diffuse and transmit light emitted from the light source; and
a control device connected to the optical element and configured to control the optical element,
herein:
each of the first liquid crystal cell and the second liquid crystal cell comprises:
a first substrate on which a first transparent electrode and a second transparent electrode extend in a first direction and are alternately arranged in a second direction orthogonal to the first direction,
a second substrate on which a third transparent electrode and a fourth transparent electrode extend in the second direction and are alternately arranged in the first direction, and
a liquid crystal layer between the first substrate and the second substrate,
the control device comprises:
a switch circuit section including a first output channel electrically connected to the first transparent electrode of the first liquid crystal cell, a second output channel electrically connected to the second transparent electrode of the first liquid crystal cell, a third output channel electrically connected to the third transparent electrode of the first liquid crystal cell, and a fourth output channel electrically connected to the fourth transparent electrode of the first liquid crystal cell,
a signal generating circuit section configured to generate a plurality of voltage signals to be input to the first transparent electrode, the second transparent electrode, the third transparent electrode, and the fourth transparent electrode of each of the first liquid crystal cell and the second liquid crystal cell, and
a first voltage signal line and a second voltage signal line connected to the switch circuit section and the signal generating circuit section, the first voltage signal line and the second voltage signal line each transmitting one of the plurality of voltage signals,
one frame period comprises a first subframe period and a second subframe period,
in the first subframe period, the switch circuit section drives so that the first voltage signal line and the first output channel are electrically connected to each other and the second voltage signal line and the second output channel are electrically connected to each other, and
in the second subframe period, the switch circuit section drives so that the first voltage signal line and the third output channel are electrically connected to each other and the second voltage signal line and the fourth output channel are electrically connected to each other.

2. The lighting device according to claim 1,
wherein:
in the first subframe period, the third output channel and the fourth output channel are in a high impedance state, and
in the second subframe period, the first output channel and the second output channel are in a high impedance state.

3. The lighting device according to claim 1,
wherein:
the switch circuit section further comprises a fifth output channel electrically connected to the first transparent electrode of the second liquid crystal cell, a sixth output channel electrically connected to the second transparent electrode of the second liquid crystal cell, a seventh output channel electrically connected to the third transparent electrode of the second liquid crystal cell, and an eighth output channel electrically connected to the fourth transparent electrode of the second liquid crystal cell,
the one frame period further comprises a third subframe period and a fourth subframe period,
in the third subframe period, the switch circuit section drives so that the first voltage signal line and the fifth output channel are electrically connected to each other and the second voltage signal line and the sixth output channel are electrically connected to each other, and
in the fourth subframe period, the switch circuit section drives so that the first voltage signal line and the seventh output channel are electrically connected to each other and the second voltage signal line and the eighth output channel are electrically connected to each other.

4. The lighting device according to claim 3,
wherein:
in the third subframe period, the first output channel, the second output channel, the third output channel, the fourth output channel, the seventh output channel, and the eighth output channel are in a high impedance state, and
in the fourth subframe period, the first output channel, the second output channel, the third output channel, the fourth output channel, the fifth output channel, and the sixth output channel are in a high impedance state.

5. The lighting device according to claim 1, wherein in the first subframe period, a phase of a first voltage signal input to the first transparent electrode of the first liquid crystal cell is reversed to a phase of a second voltage signal input to the second transparent electrode of the first liquid crystal cell.

6. The lighting device according to claim 5, wherein in the second subframe period, a phase of a third voltage signal input to the third transparent electrode of the first liquid crystal cell is reversed to a phase of a fourth voltage signal input to the fourth transparent electrode of the first liquid crystal cell.

7. The lighting device according to claim 5, wherein in the second subframe period, a phase of a third voltage signal input to the third transparent electrode of the first liquid crystal cell is a same as a phase of a fourth voltage signal input to the fourth transparent electrode of the first liquid crystal cell.

8. A lighting device, comprising:
a light source;
an optical element comprising a first liquid crystal cell and a second liquid crystal cell, and configured to diffuse and transmit light emitted from the light source; and
a control device connected to the optical element and configured to control the optical element,
wherein:
each of the first liquid crystal cell and the second liquid crystal cell comprises:
a first substrate on which a first transparent electrode and a second transparent electrode extend in a first direction and are alternately arranged in a second direction orthogonal to the first direction,
a second substrate on which a third transparent electrode and a fourth transparent electrode extend in the second direction and are alternately arranged in the first direction, and
a liquid crystal layer between the first substrate and the second substrate,
the control device comprises:
a switch circuit section including a first output channel electrically connected to the first transparent electrode of the first liquid crystal cell, a second output channel electrically connected to the second transparent electrode of the first liquid crystal cell, a third output channel electrically connected to the third transparent electrode of the first liquid crystal cell, a fourth output channel electrically connected to the fourth transparent electrode of the first liquid crystal cell, a fifth output channel electrically connected to the first transparent electrode of the second liquid crystal cell, a sixth output channel electrically connected to the second transparent electrode of the second liquid crystal cell, a seventh output channel electrically connected to the third transparent electrode of the second liquid crystal cell, an eighth output channel electrically connected to the fourth transparent electrode of the second liquid crystal cell,
a signal generating circuit section configured to generate a plurality of voltage signals to be input to the first transparent electrode, the second transparent electrode, the third transparent electrode, and the fourth transparent electrode of each of the first liquid crystal cell and the second liquid crystal cell, and
a first voltage signal line, a second voltage signal line, a third voltage signal line, and a fourth voltage signal line connected to the switch circuit section and the signal generating circuit section, the first voltage signal line, the second voltage signal line, the third voltage signal line, and the fourth voltage signal line each transmitting one of the plurality of voltage signals,
one frame period comprises a first subframe period and a second subframe period,
in the first subframe period, the switch circuit section drives so that the first voltage signal line, the second voltage signal line, the third voltage signal line, and the fourth voltage signal line are electrically connected to the first output channel, the second output channel, the third output channel, and the fourth output channel, respectively, and
in the second subframe period, the switch circuit section drives so that the first voltage signal line, the second voltage signal line, the third voltage signal line, and the fourth voltage signal line are electrically connected to the fifth output channel, the sixth output channel, the seventh output channel, and the eighth output channel, respectively.

9. The lighting device according to claim 8,
wherein:
in the first subframe period, the fifth output channel, the sixth output channel, the seventh output channel, and the eighth output channel are in a high impedance state, and
in the second subframe period, the first output channel, the second output channel, the third output channel, and the fourth output channel are in a high impedance state.

10. The lighting device according to claim 8, wherein in the first subframe period, a phase of a first voltage signal input to the first transparent electrode of the first liquid crystal cell is reversed to a phase of a second voltage signal input to the second transparent electrode of the first liquid crystal cell, and a phase of a third voltage signal input to the third transparent electrode of the first liquid crystal cell is reversed to a phase of a fourth voltage signal input to the fourth transparent electrode of the first liquid crystal cell.

11. The lighting device according to claim 8, wherein in the first subframe period, a phase of a first voltage signal input to the first transparent electrode of the first liquid crystal cell is reversed to a phase of a second voltage signal input to the second transparent electrode of the first liquid crystal cell, and a phase of a third voltage signal input to the third transparent electrode of the first liquid crystal cell is a same as a phase of a fourth voltage signal input to the fourth transparent electrode of the first liquid crystal cell.
